(19) United States
(12) Patent Application Publication
(10) Pub. No.: US 2026/0307335 A1
(43) Pub. Date: Oct. 8, 2026

(54) METHODS AND SYSTEM FOR REMOVAL OF POWDER FROM AN ADDITIVELY MANUFACTURED PART

(71) Applicant: PostProcess Technologies, Inc., Buffalo, NY (US)

(72) Inventors: Greg C. Piske, Buffalo, NY (US); Craig Ostrum, Buffalo, NY (US)

(73) Assignee: PostProcess Technologies, Inc., Buffalo, NY (US)

(21) Appl. No.: 19/485,416

(22) PCT Filed: Jun. 6, 2024
(86) PCT No.: PCT/US2024/032731

§ 371 Date: Nov. 18, 2025

Related U.S. Application Data
(60) Provisional application No. 63/471,990, filed on Jun. 9, 2023.

(51) Int. Cl. B29C 64/357; B29C 64/245; B29C 64/25; B33Y 30/00; B33Y 40/00

(52) U.S. Cl. CPC B29C 64/357; B29C 64/245; B29C 64/25; B33Y 30/00; B33Y 40/00

(57) ABSTRACT

A system and method are disclosed for removal of unwanted powder material from additively manufactured objects. The system and method include a transfer channel located in a housing of the system. The transfer channel includes at least a loading or receiving area and a processing area. An exchangeable printer frame used in an additive manufacturing printer contains additively manufactured objects and unwanted powder material. The exchangeable printer frame is received in the loading area. The additively manufactured objects and unwanted powder material are removed from the exchangeable printer frame and conveyed along the transfer channel onto a platform in the processing area. The unwanted powder material is removed by vibratory action and falls through openings in the platform. The now depowdered additively manufactured objects are then removed from the processing area.

### REFERENCE TO RELATED APPLICATIONS

The present application claims priority to U.S. Provisional Patent Application Ser. No. 63/471,990, filed Jun. 9, 2023, the entire disclosure of which are incorporated herein by reference. The present application incorporates by reference WO 2021/211658A1.

### FIELD OF THE INVENTION

This disclosure relates generally to additive manufacturing and in particular to a system and method for removing unwanted material from parts made by a 3D printer in a printing stage of the overall additive manufacturing process.

### BACKGROUND OF THE INVENTION

In some kinds of additive manufacturing processes (also referred to as 3D printing processes), such as Selective Laser Sintering (SLS), Electron Beam Melting (e-beam), Multi-Jet Fusion (MJF), or Powder Bed Fusion (PBF), solid objects are manufactured using a computer-controlled beam or print head to fuse or solidify portions (such as the walls) of the object a layer at a time until the entire three-dimensional object is formed. After the solid three-dimensional object is formed, unwanted material, such as a powder from which the object was formed, may cling to or encase the solid object. It is necessary to remove this unwanted material from the solid printed object before the next step, which may include painting, curing, passivation, coating, assembly, and so on. Removal of unwanted powder material from additively manufactured parts is sometimes referred to as decaking or depowdering. In some additive manufacturing processes, printed objects have unwanted support material on them after the printing stage. Some additively manufactured objects may have rough surfaces or build lines after being formed by the printer. Finishing processes are needed to remove unwanted material, such as powder or support material, or to smooth rough surfaces of additively manufactured objects.

Additional disclosure about techniques and processes for additive manufacturing and removal of unwanted material from objects formed by additive manufacturing can be found in copending patent applications, US20190176403, US20190202126, US20190270248, US20190275745, US20190315065, US20170348910, WO 2021/211658 and PCT/US2020/041396, which are assigned to the owner of the present application and the entire disclosures of which are incorporated by reference herein.

### SUMMARY OF THE INVENTION

A system and method are disclosed for removal of unwanted powder material from additively manufactured objects. The system and method include a transfer channel located in a housing of the system. The transfer channel includes at least a loading or receiving area and a processing area. An exchangeable printer frame used in an additive manufacturing printer contains additively manufactured objects and unwanted powder material. The exchangeable printer frame is received in the loading area. The additively manufactured objects and unwanted powder material are removed from the exchangeable printer frame and conveyed along the transfer channel onto a platform in the processing area. The unwanted powder material is removed by vibratory action and falls through openings in the platform. The now depowdered additively manufactured objects are then removed from the processing area.

### BRIEF DESCRIPTION OF THE FIGURES

FIG. 1 is a perspective view showing an embodiment of a system for removing unwanted material from additively manufactured parts.

FIG. 2 is a cutaway side view of the embodiment shown in FIG. 1.

FIG. 3 is a flowchart showing an embodiment of a process performed by the system of FIGS. 1 and 2 for removing unwanted material from additively manufactured parts.

FIG. 4 shows the embodiment of FIG. 2 at a stage of the process of FIG. 3.

FIG. 5 is a cutaway side view of another embodiment of a system for removing unwanted material from additively manufactured parts.

FIG. 6 is a flowchart showing a process performed by the system of FIG. 5.

FIGS. 7A and 7B are perspective views of a portion of another embodiment of a system for removing unwanted material from additively manufactured parts.

FIGS. 8A, 8B, and 8C depict different types of vibrations that can be used in the embodiments disclosed herein.

FIG. 9 is a cutaway side view of another embodiment of a system for removing unwanted material from additively manufactured parts.

FIG. 10 shows a side view of an outside of the system shown in FIG. 9.

FIG. 11 shows a perspective view of the processing platform in the system shown in FIG. 9.

FIG. 12 shows a perspective view of another embodiment of a system for removing unwanted material from additively manufactured parts.

FIG. 13 is a diagram of the embodiment of FIG. 12.

FIG. 14 is a perspective view of the movable container shown in FIG. 13.

FIG. 15 shows a perspective view of another embodiment of a system for removing unwanted material from additively manufactured parts.

FIG. 16 shows a perspective view of the system shown in FIG. 15 with panels of the housing removed.

FIG. 17A shows the processing section of FIG. 16 with the platform grate in an upper position.

FIG. 17B shows the processing section of FIG. 16 with the platform grate in a lower position.

### DETAILED DESCRIPTION OF THE INVENTION

Although the invention will be described in terms of certain examples, other examples, including examples that do not provide all of the benefits and features set forth herein, are also within the scope of the invention. Various changes to the system and method may be made without departing from the scope of the invention.

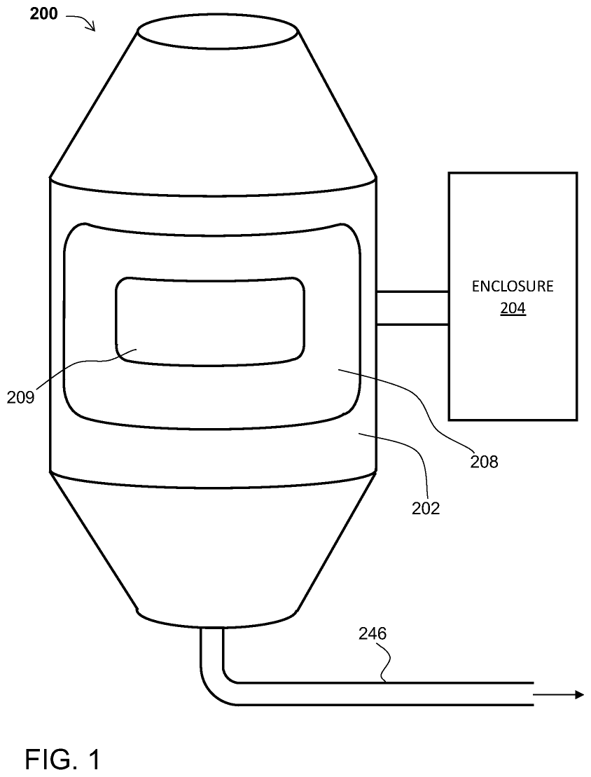

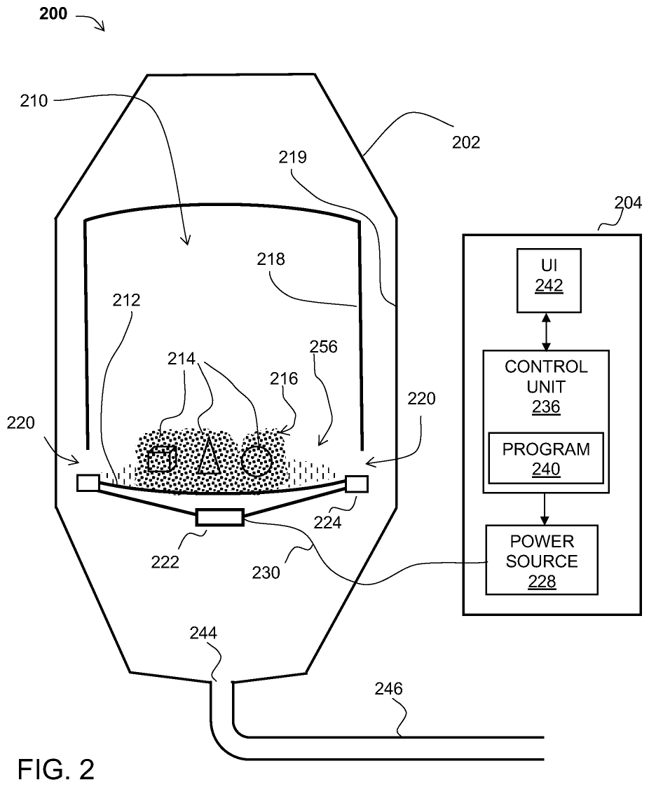

An embodiment of a system 200 for removing unwanted material from additively manufactured parts (also referred to herein as “objects”) is shown in FIG. 1. The system 200 includes a chamber 202 and an adjacent enclosure 204. The chamber 202 has a door 208 that can be opened and closed. The door 208 provides access to a chamber interior 210 (shown in FIG. 2). The door 208 includes a seal around it to prevent or reduce air, powder, or sound leakage from the chamber 202. The chamber 202 has a size suitable for containing therein additively manufactured parts (also referred to as “objects”), including the unwanted material formed in that portion of the additive manufacturing process performed by a 3D printer. The chamber 202 and the door 208 may be made of a suitable, durable material such as plastic, metal (e.g., stainless steel, polycarbonate), or a combination thereof. The chamber 202 also includes a viewing pane 209. The viewing pane 209 is composed of a transparent material such as glass or plastic. The viewing pane 209 enables an operator to view the chamber interior 210. The viewing pane 209 is located in a wall of the chamber. In one embodiment, the viewing pane 209 is located in the chamber door 208.

FIG. 2 shows a cutaway view of the chamber 202. Located in the interior 210 of the chamber 202 is a platform 212. The platform 212 is made of a durable material. Suitable materials include a metal, such as stainless steel, aluminum, plastic, cardboard, or paper. The platform 212 is sized and adapted for having placed thereupon one or more parts 214 that had been formed by an additive manufacturing process, such as SLS. In one embodiment, the platform 212 is circular with a diameter of approximately 25 cm (10 inches) although other sizes are suitable. In this embodiment, the parts 214 are approximately 2.4 to 4 grams. The quantity of parts 214 that can be placed on the platform 212 and finished at one time can vary. In this embodiment, between 6 and 110 or more or fewer parts can be placed on the platform 212 and finished at one time. Other quantities may also be suitable. When formed by the additive manufacturing process, the parts 214 have unwanted material 216 remaining thereupon. In this example, the unwanted material 216 is a nylon powder. Further, when formed by this additive manufacturing process, the parts 214 may be encased in the unwanted powder material 216.

As shown in FIG. 2, an interior wall 218 of the chamber 202 is spaced from an outer wall 219. In this embodiment, the interior wall 218 extends around the entire perimeter of the interior 210 of the chamber 202 spaced inward from the outer wall 219. The interior wall 218 defines an inner portion of the interior 210. In this embodiment, the inner wall 218 is open on a top side. The platform 212 is mounted in the chamber 202 so that it is spaced from the interior wall 218, thereby forming a gap 220 between an edge of the platform 212 and the interior wall 218. The gap 220 does not need to extend around the entire perimeter of the platform 202. The gap 220 has a size narrow enough to prevent any of the objects 214 located on the platform 212 from falling though the gap 220, but wide enough so that any unwanted material 216 detaching from the objects 214 can pass though the gap 220 during the finishing process. In one embodiment, the gap 220 is approximately 1.27 cm (½ inch), but other sizes may be suitable depending on the size of the parts to be placed on the platform 212.

The platform 212 is mounted in the chamber 202 so that it can move (i.e., vibrate). This can be accomplished in various different ways. One suitable way is to make the connection between the platform 212 and the chamber 202 a flexible connection. Another way is to provide a hinged or loose connection. Another way is to provide a solid fixed rim 224 that is fixed to the chamber outer wall 219, but which has a flexible connection to a middle portion of the platform 212, similar to a speaker diaphragm.

Connected to the underside of the platform 212 is a transducer 222. The transducer 222 is operatively connected to the platform 212 to impart vibrations to it. In one embodiment, the transducer is an electromagnetic coil. The transducer 222 is connected to a power source 228 by means of a wire or cable 230. The power source 228 is located outside the chamber 202 in the enclosure 204 located adjacent to the chamber 202. The cable 230 extends through the walls of the chamber 202 and the enclosure 204 to connect the transducer 222 to the power source 228. In one embodiment, the power source 228 is an amplifier.

In the enclosure 204 is a control unit 236. In alternative embodiments, the control unit 236 may be located remotely. The control unit 236 is operatively connected to the hardware of system 200, including the power source 228. In one embodiment, the control unit 236 is a personal computer (PC) running a suitable operating system, such as the Windows® operating system. Alternatively, the control unit 236 may be any other computing platform, including a smartphone running Android or iOS. In one embodiment, the control unit 236 and power source 228 are combined into one unit.

The control unit 236 includes appropriate programming 240 by which the system 200 can be operated, as explained below.

Connected to the control unit 236 is a user interface 242. The user interface 242 includes a touch screen or other hardware for receiving input from a (human) user operator and providing an information output to the user operator. In the embodiment shown in FIG. 2, the user interface 242 is shown located on the enclosure 204. In alternative embodiments, the user interface 242 may be located elsewhere, including remotely.

Located in the bottom floor of the chamber 202 is a discharge chute 244. The discharge chute 244 connects to a discharge exhaust 246 for removing the unwanted material 216 that is removed from the parts 214. The exhaust 246 is connected to a vacuum or suction to withdraw the unwanted material 216 from the chamber 202. A filter system (not shown) may be included in-line with the exhaust 246 to catch particles.

### Operation

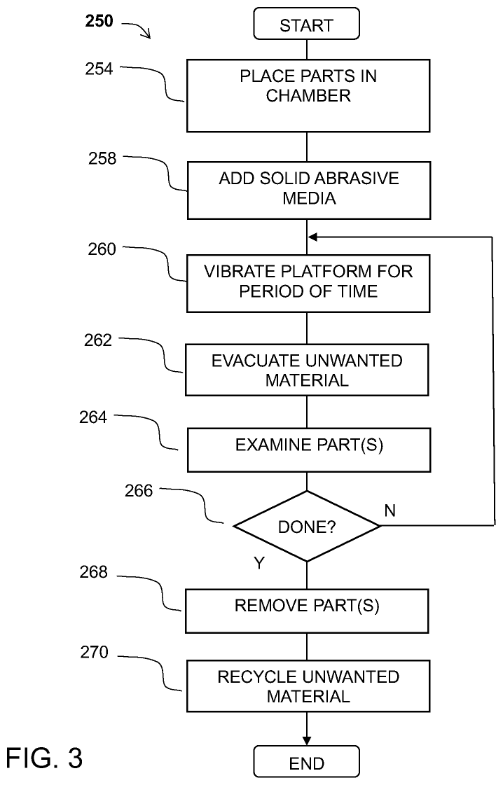

FIG. 3 shows a flowchart of a process 250 performed by or with the system 200 of FIGS. 1 and 2. In step 254, the objects 214, which had been manufactured by an additive manufacturing process and which are encased in unwanted material (e.g., powder) 216, are placed in the system 200, specifically on the platform 212 inside the chamber 202.

Next, solid abrasive media 256 is placed on the platform 212 (Step 258). This step is optional and may be omitted in some embodiments. The solid abrasive media 256 can be mixed or interspersed with the parts 214. In one embodiment, the solid abrasive media 256 is UPM. In another example, plastic acrylic media particles having an irregular shape are used. Other kinds of solid abrasive media may be suitable, including M-CAT. The amount of solid abrasive media 256 placed on the platform is dependent on the quantity and sizes of the parts 214. In one embodiment, approximately ½ cup of solid abrasive media 256 is used. After the parts 214 encased in unwanted material 216 and the solid abrasive media 256 are placed on the platform 212 in the chamber 202, the door 208 is closed.

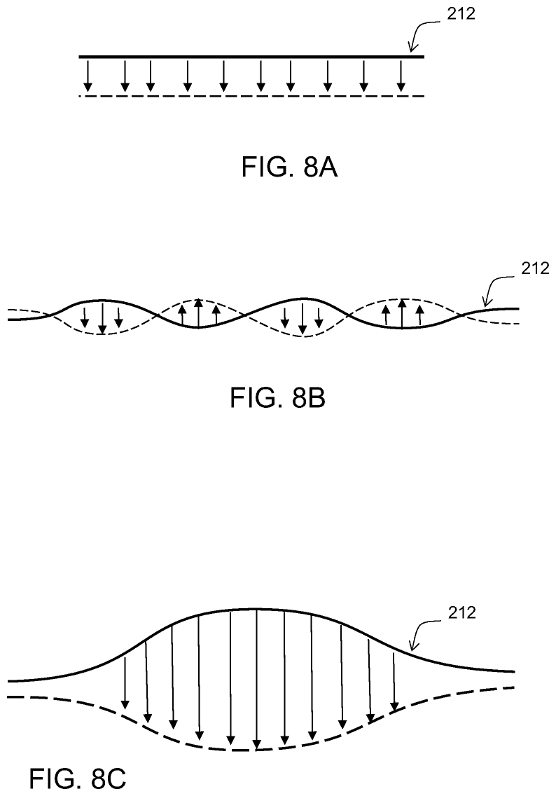

The control unit 236 is operated (e.g., by means of the user interface 242) to cause the power source 228 to energize the transducer 222 thereby causing the platform 212 to vibrate (Step 260). There are different kinds of vibration that can be applied to the vibratory platform 212. FIGS. 8A, 8B, and 8C depict different types of vibrations that can be applied to the platform 212. (The depictions in FIGS. 8A, 8B and 8C are not necessarily to scale. These types of vibrations are not the only types that can be applied and other types may be suitable.) In FIG. 8A, a uniformly vertical vibratory action is depicted. In this type of vibration, the platform surface moves uniformly across its width with an up and down motion, similar to an audio speaker. FIG. 8B shows the platform 212 vibrating with a sinusoidal motion, in which parts of the platform move upward while other parts move downward at the same time. This type of vibration is characteristic of Chladni plates in which locations of movement are separated by relatively stationary locations, corresponding to nodes of relative stability. FIG. 8C shows another type of vibratory motion in which the platform 212 moves with a trampoline-type of motion, with a central portion having a large amplitude with the amplitude diminishing toward the edges.

An objective in selecting a type of vibration (as well as selecting a waveform, frequency and amplitude of vibration) is to separate the additively manufactured parts from the unwanted material attached thereto. One way to effect this separation is to impart disparate movement between the additively manufactured parts and the unwanted material, thereby causing the unwanted material to detach from the additively manufactured parts. In some cases, the type of vibratory action is selected to impart a resonance with either the additively manufactured parts or the unwanted material, but not both. For example, a vibration can be selected that causes the unwanted material to resonant at a certain frequency, but that causes the additively manufactured parts to not vibrate at all. In another case, the type of vibratory action is selected to impart a resonance with the additively manufactured parts at a first frequency and to impart a resonance with the unwanted material at a second, different frequency. Thus, causing the additively manufactured parts or the unwanted material to vibrate differently from the other can effect detachment of the unwanted material from the additively manufactured parts. Further, selection of an appropriate vibration can also cause the unwanted material to move away from the additively manufactured parts and even cause the unwanted material to move off the platform, in a manner similar to how powder can be caused to accumulate at nodes on a Chladni plate.

Reference is made to applications in cymatics that address and describe wave phenomena. The selection of the type of vibration, the type of waveform, the frequency and amplitude of vibration, the duration of vibration, and whether different types of waveforms, frequencies, or amplitudes are used depends on several factors. These factors include the material composition of the additively manufactured parts, the sizes and geometry of the additively manufactured parts, the amount of unwanted material attached to the additively manufactured parts, and other factors.

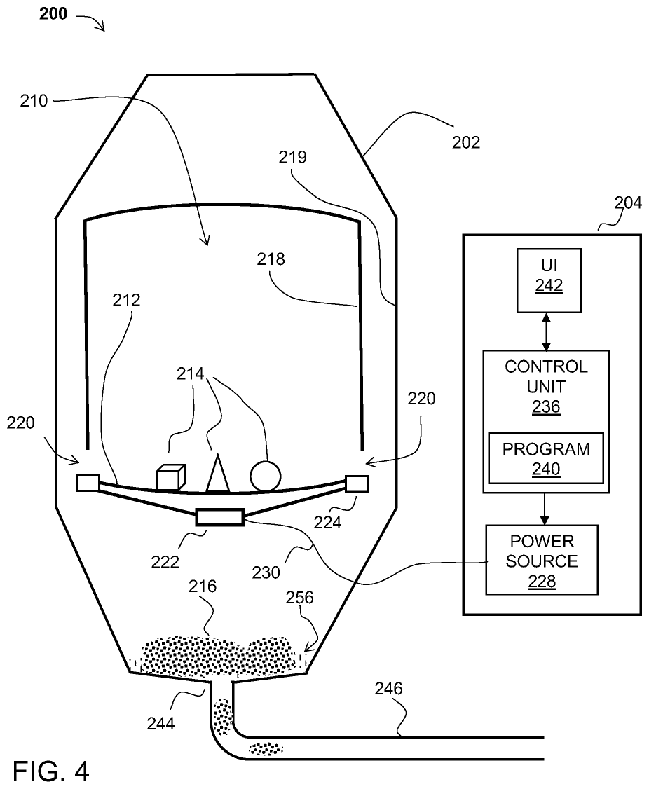

Referring again to FIG. 3, in this embodiment, the power source 228 applies a sinusoidal wave to the transducer 222. In alternative embodiments, other types of waveforms may be suitable. In this embodiment, the platform 212 is vibrated at a frequency of between 75 and 135 Hertz, although other frequencies may be suitable. The platform 212 is vibrated for a period of time. In this embodiment, the platform 212 is vibrated for 30 minutes. Other durations of time may be suitable. While the platform 212 is being vibrated, the vibration of the platform 212 is transferred to the parts 214 and the unwanted material 216 located on the platform 212. Movement is imparted between the parts 214 and the unwanted material 216. The vibration of the vibratory platform 212 causes the unwanted material 216 to detach from the parts 214. The solid abrasive media 254, shaking among the parts 214, helps with this process. In cases in which the parts 214 are relatively small, the vibratory amplitude large, or the vibratory frequency low, the parts 214 may bounce on the platform 212. In cases in which the parts 214 are relatively large, the vibratory amplitude small, or the vibratory frequency high, the parts 214 may remain relatively stationary on the platform 212. As the vibratory action continues, some or all the unwanted material 216 that has detached from the parts 214 eventually moves or bounces to the edge of the platform 212 and falls through the gap 220 to the bottom of the chamber 202, as shown in FIG. 4. Some or all the abrasive material 254 may also fall to the bottom of the chamber 202. Because the parts 214 are too large to fall through the gap 220, they remain on the platform 212. As the unwanted material 216 accumulates at the bottom of the chamber 202, it can be evacuated through the chute 244 and exhaust 246 by suction or other means (Step 262, in FIG. 3).

Referring to FIG. 3, the parts 214 can be examined to determine if the unwanted material has been sufficiently removed (Step 264). This step may be performed manually (e.g., by an operator) by stopping the vibration and examining the parts 214. Alternatively, this step may be performed using machine vision, or other automatic processes. If it is determined that the parts 214 need more finishing, the parts 214 are placed again on the platform 212 and the platform 212 is vibrated again (Steps 266 and 260). The parts 214 may be rotated or moved on the platform 212 to facilitate powder removal. The steps of vibrating the parts 214 on the platform 212 and then examining them may be conducted as many times as needed.

Upon examination, if it is determined that the parts 214 are sufficiently finished (e.g., sufficient unwanted material 216 has been removed), the parts 214 can be removed from the chamber 202 (Steps 266 and 268). The unwanted material 216 that had been removed from the parts 214 is recycled or otherwise disposed of (Step 270). Then, the process 250 ends. The parts 214 are ready for the next stage, which may include further powder removal, curing, washing, painting, passivation, assembly, and so on.

### Alternative Embodiments

First alternative Embodiment

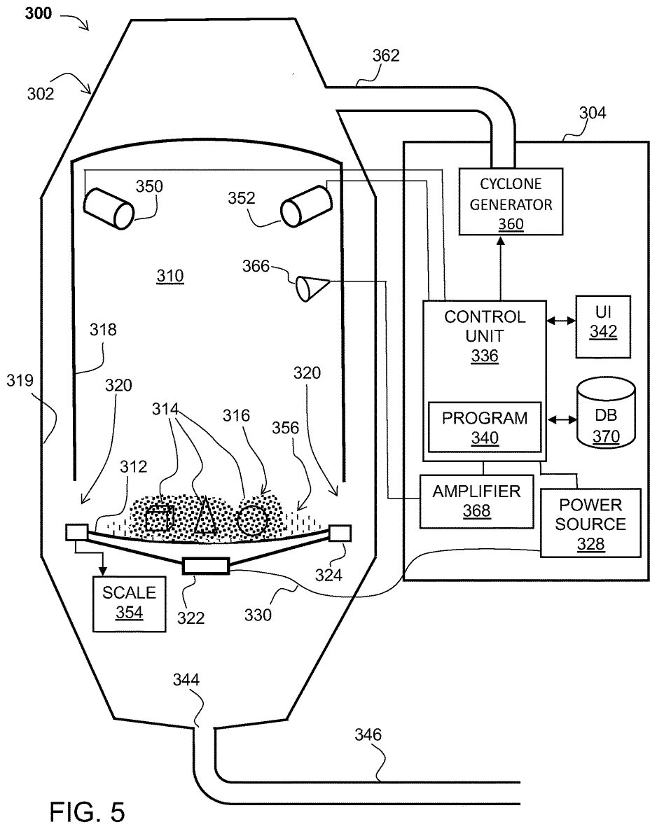

FIG. 5 shows another embodiment of a system for removing unwanted material from additively manufactured parts. In FIG. 5, a system 300 includes components that are similar to those described in connection with the embodiment of the system 200 shown in FIGS. 1, 2, and 4. The system 300 includes a chamber 302 having a door (not shown, but similar to the door 208 in FIG. 1) and an adjacent enclosure 304. Located in an interior of the chamber 302 is a platform 312, sized and adapted for having placed thereupon additively manufactured parts 314 that have unwanted material (e.g., nylon powder) 316 remaining thereupon and encasing in the parts 314.

The platform 312 is spaced from an interior wall 318 of the chamber 302, by a gap 320. A transducer (or actuator) 322 is operatively connected to an underside of the platform 312 to impart vibrations to it. The transducer 322 is connected by a cable 330 to a power source 328 located in the enclosure 304. A control unit 336 is operatively connected to the hardware of system 300, including the power source 328 and a user interface 342. The control unit 336 includes appropriate programming 340. A discharge chute 344 is located in the bottom floor of the chamber 302 and connects to a discharge exhaust 346.

The system 300 also includes one or more cameras 350. The cameras 350 are located in the chamber 302 adjacent to and/or above the platform 312. The cameras 350 are connected to the control unit 336 by appropriate means, such as cabling. The cameras 350 are oriented and adapted to obtain imagery (including video) of the interior of the chamber 302 including anything located on the platform 312 such as the parts 314, the unwanted material 316, and the solid abrasive media 356, if any.

The system 300 also includes one or more additional sensors 352. The additional sensors 352 are located in the chamber 302 adjacent to and/or above the platform 312. These additional sensors 352 are connected to the control unit 336 by appropriate means, such as cabling. These additional sensors 352 may include one or more microphones, thermometers, accelerometers, scanners, radar, lidar, and so on. These additional sensors 352 are adapted to measure properties of anything on the platform 312 or in the chamber 302.

The system 300 also includes a scale 354. The scale 354 is located in the chamber 302 and connected to the control unit 336 by appropriate means, such as cabling (not shown). The scale 354 is adapted to measure the weight of anything located on the platform 312 and provide data indicative thereof to the control unit 336.

The system 300 also includes a cyclone generator 360. The cyclone generator 360 connects to the interior of the chamber 302 by means of one or more inlet ducts or tubes 362. The cyclone generator 360 is connected to a source of air, such as ambient air. The cyclone generator 360 provides flow of air through the interior of the chamber 302. The cyclonic generator 360 may include an electric driven impeller or blower to create the air flow. The inlet ducts 362 are located and arranged to create a circular, cyclonic airflow within the chamber 302. The cyclone generator 360 is operatively connected to and operates under the control of the control unit 336. In one embodiment, the cyclonic generator 360 provides suction (negative pressure) in a vertical direction to remove loose unwanted powder 316. The cyclonic generator 360 may force unwanted powder 316 towards the top or bottom of the chamber 302.

Mounted in the chamber 302 are one or more audio transducers 366. The audio transducers 366 may be horns, speakers, diaphragms, vibratory plates or membranes, or other devices capable of forming audio (i.e., sonic, acoustic) waves. The audio transducers 366 are adapted to provide audio waves in the air inside the chamber 302. The audio transducers 366 are adapted to provide audio waves at different frequencies and amplitudes based on signals input thereto. In this embodiment, the audio transducers 366 are mounted and oriented to project audio waves at the parts 314 and unwanted material 316 on the platform 312. The audio transducers 366 are operatively connected to an amplifier 368, which in turn is connected to the control unit 336.

The system 300 also includes a profile database 370. The profile database 370 is a data storage adapted to contain various different operational profiles or recipes. The operational profiles are comprised of stored data that includes operating parameters for different parts to be placed in the system 300 for removal of unwanted material. The profile database 370 is operatively connected to the control unit 336. The profile database 370 may be located with the control unit 336 in the housing 304 or may be located remotely. The profile database 370 is adapted to exchange data with the control unit 336.

### Operation

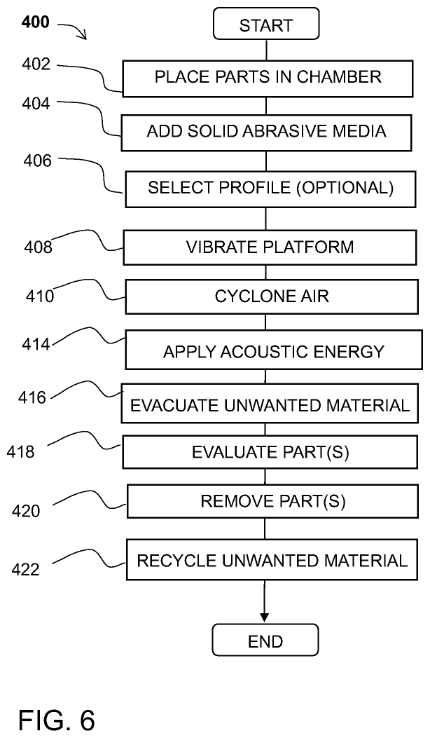

FIG. 6 shows a flowchart of a process 400 performed by or with the system 300 of FIG. 5. In step 402, the objects 314, which had been manufactured by an additive manufacturing process and which are encased in unwanted material (e.g., powder) 316, are placed on the platform 312 inside the chamber 302.

Next, solid abrasive media 356 is placed on the platform 312 and mixed or interspersed with the parts 314 (Step 404). At this point, the door 308 of the chamber 302 is closed.

If the system 300 is to be operated in automatic mode, a profile can be selected (Step 406). This step is optional. A profile can be selected using the user interface 342.

Profiles are stored in the profile database 370. An appropriate profile can be selected based on matching parameters, such as the type of material from which the parts are made, the quantity of parts in the chamber 302, the dimensions of the parts, the geometry of the parts, desired finish properties, and so on. A new profile can also be generated from characteristics and prior history of finishing operations. Alternatively, the system 300 can be operated in a manual mode in which the operating characteristics, such as the air flow, vibrating frequency, vibrating amplitude, temperature, acoustic energy, duration, and so on, are selected by an operator via the user interface 342.

Depending on the operating characteristics chosen, one or more of the following steps are performed. A vibratory motion is applied to the platform 312 (Step 408). The cyclone generator 360 is operated to create a cyclonic airflow in the chamber (Step 410). The acoustic transducer(s) 366 are operated to create sonic waves that impact the parts 314 and unwanted material 316 (Step 414). Unwanted material 316 that falls to the bottom of the chamber 302 is evacuated via the chute 344 and exhaust 346 (Step 416). The parts 324 are evaluated to determine the progress of the removal of the unwanted material 316 (Step 418). This evaluation step may be performed after a duration of time, regularly, intermittently, or continuously. This evaluation step may be performed using input from the scale 354, the cameras 350, the other sensors 352, direct visual observation, or other means. The evaluation step may be performed with the assistance of software tools, such as image recognition or machine vision programming that evaluates the progress of the removal of the unwanted material. These steps (Steps 408, 410, 414, 416, 418) may be performed all at once, or may be performed in stages of one or more at a time, in overlapping stages or non-overlapping stages, or may be performed cyclically, on-off, intermittently, or according to another scheme or routine.

After the unwanted material 316 is sufficiently removed, the parts 314 are removed from the chamber 302 (Step 420). The unwanted material 316 which has been evacuated via the exhaust 346 is recycled or otherwise disposed of (Step 422).

Second alternative embodiment

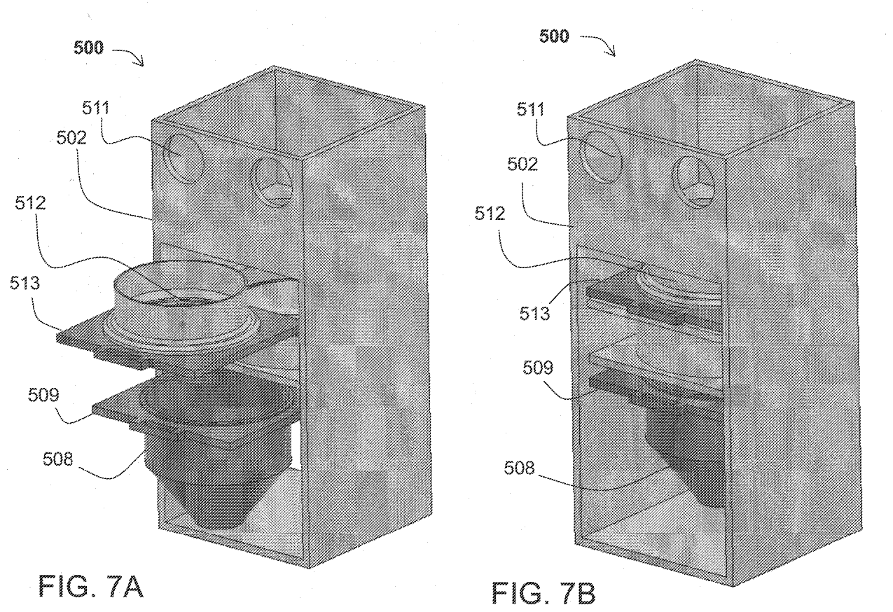

FIGS. 7A and 7B show another alternative embodiment of a system 500 for removing unwanted material from additively manufactured parts. Referring to FIGS. 7A and 7B, a chamber 502 includes a vibratory platform 512. Parts (not shown) to be cleaned (decaked) can be placed on the vibratory platform 512. The vibratory platform 512 is mounted in a slidable tray 513 that enables the vibratory platform 512 to be slid from a position outside the chamber 502 (as shown in FIG. 7A) into a position inside the chamber 502 (shown in FIG. 7B). The slidable tray 513 enables the vibratory platform 512 to be slid into a position outside the chamber 502 to facilitate placing parts onto the vibratory platform 512 and inspecting the parts to evaluate the progress of removal of unwanted material. This enables an operator to remove some parts that are finished, leave other parts that need more processing on the platform 512, and add additional parts if there is room on the platform 512. In FIGS. 7A and 7B, the unwanted material that is removed from the additively manufactured parts falls off the vibratory platform 512 to a lower chamber portion 508. The lower chamber portion 508 is mounted in a slidable tray 509 that enables the lower chamber portion 508 to be slid from a position outside the chamber 502 (as shown in FIG. 7A) into a position inside the chamber 502 (shown in FIG. 7B). The embodiment 500 shown in FIGS. 7A and 7B also includes glove ports 511 for using gloves (not shown). Gloves enable an operator to examine (through a viewing pane, not shown) and arrange parts on the platform 512 without opening the chamber 502. The embodiment of the system 500 in FIGS. 7A and 7B can be operated in a manner similar to the system 200 shown in FIGS. 1, 2, and 4 or the system 300 shown in FIG. 5.

### Third Alternative Embodiment

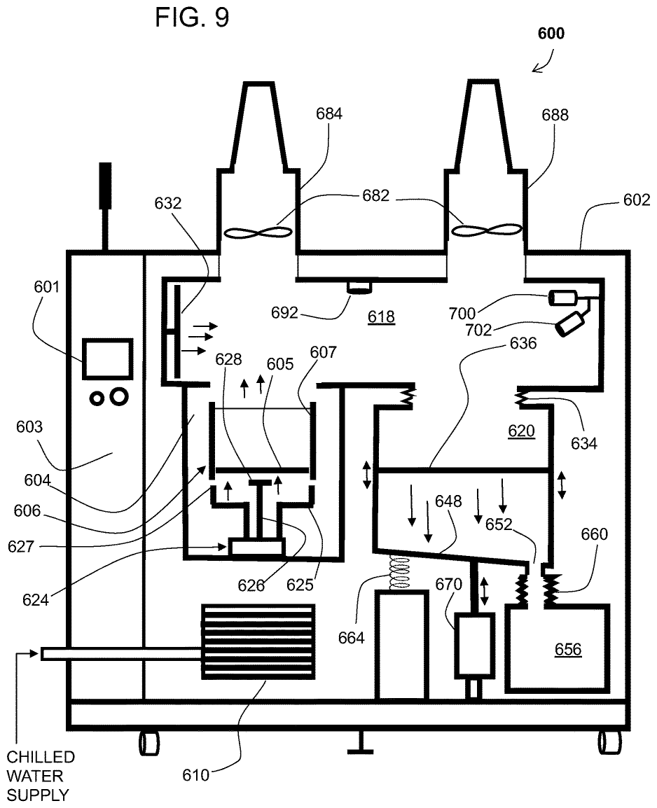

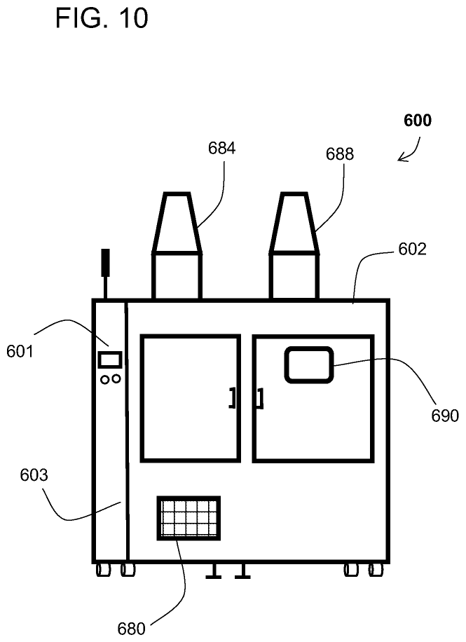

FIGS. 9 and 10 show another alternative embodiment. FIGS. 9 and 10 show a system 600 for removing powder from additively manufactured objects. The system 600 uses processes similar to the other embodiments disclosed herein to remove powder from 3D printed objects. The system 600 includes additional components and features including features that facilitate handling and transfer of objects encased in powder from a 3D printer that produced the objects.

The system 600 includes a housing 602 that contains multiple compartments and chambers, as described herein. The system 600 includes a control panel 601. The control panel 601 is located at a side of the housing 602 in an enclosure 603 or alternatively the control panel 601 can be located elsewhere at a convenient location on or in the housing 602. The control panel 601 includes a user interface. The user interface enables an operator to input instructions, commands, parameters, and other information into the system 600 as well as receive information and other output from the system 600. The control panel 601 is connected to a controller of the system 600.

FIG. 9 shows the housing 602 with its front panels removed. Inside the housing 602 is a receiving area 604. The receiving area 604 has a size and dimensions to receive therein an exchangeable printing frame 606. The exchangeable printing frame 606 is a component used in a 3D printer that uses powder bed technology to produce objects. The exchangeable printing frame 606 is a box-like structure comprised of outer side walls 607 with an open upper side and a bottom floor comprised of a movable platform 605 that can translate vertically up and down within the outer side walls 607.

In a powder bed 3D printer, an object is printed in a printing frame a layer at a time. In a 3D printer, with the platform 605 located in an upper position relative to the outer side walls 607, a bed of powder is spread over the platform 605. An energy beam (e.g., a laser, UV light, electron, etc.) is directed across the bed of powder causing the powder to fuse thereby forming a layer of the object. Then, the movable platform 605 is lowered slightly relative to the outer side walls 607 and another layer of powder is spread over the movable platform 605. The beam is directed across the new layer of powder to form another layer of the object. The process is repeated to form the entire object. Depending on the sizes of the objects being printed, multiple objects can be printed in the exchangeable printing frame 606 at the same time. When the printing is finished, the movable platform 605 is at a bottom position in the exchangeable printing frame 606 and the entire formed solid objects are encased in unfused powder in the exchangeable printing frame 606.

In the system 600 in FIG. 9, the exchangeable printing frame 606 from a 3D powder bed printer is fitted into the receiving area 604. In this embodiment, the receiving area 604 includes a tray that can be slid outward automatically from the receiving area 604 to receive therein the exchangeable printing frame 606. After the exchangeable printing frame 606 is installed in the tray, the tray is slid back into the receiving area 604. The exchangeable printing frame 606 contains the objects that were printed by the 3D printer as well as the unfused powder surrounding and encasing the objects. In this embodiment, the receiving area 604 has specific dimensions to accommodate an exchangeable printing frame from a specific 3D printer. In alternative embodiments, the receiving area 604 may have different dimensions to accommodate sizes of frames from different printers. Alternatively, the receiving area 604 may have adjustable dimensions that can be adjusted to accommodate different sizes of frames from different 3D printers. In one embodiment, a sealing member (not shown) engages the exchangeable printing frame 606 to provide an airtight seal around it.

Below the receiving area 604 is a cooling device 610. In one embodiment, the cooling device 610 is a radiator that receives a circulating fluid, such as chilled water or water from a facility water supply. The cooling device 610 serves to reduce the temperature of the powder and objects in the exchangeable printing frame 606, if necessary. In one embodiment, it is preferable that the powder and objects in the exchangeable printing frame 606 be below approximately 100° C. One or more temperature sensors (not shown) located in the receiving area 602 can be used to measure the temperature of the powder and objects in the exchangeable printing frame 606 in the receiving area 602.

Adjacent to the receiving area 604 is a processing chamber 620 (or parts bin). Above the receiving area 604 and the processing chamber 620 is a transfer chamber 618. The transfer chamber 618 extends horizontally over the receiving area 602 and the processing chamber 620. A bottom wall of the transfer chamber 618 includes a first opening into the receiving area 602 and a second opening into the processing chamber 620.

A lift mechanism 624 is located below the receiving area 604. The lift mechanism 624 includes two components: an outer portion component 625 and an inner portion component 626. An upper end 627 of the outer portion component 625 engages the outer walls 607 of the exchangeable printing frame 606 when the exchangeable printing frame 606 is in the receiving area 602. An upper end 628 of the inner portion component 626 engages the movable platform 605 of the exchangeable printing frame 606 when the exchangeable printing frame 606 is in the receiving area 602. The lift mechanism 624 is operable to elevate the exchangeable printing frame 606 toward the opening into the transfer chamber 618. When an upper side of the exchangeable printing frame 606 is aligned and sealed with a bottom of the transfer chamber 620, the outer portion component 625 ceases to elevate the outer walls 607 of the exchangeable printing frame 606 but the inner portion component 626 continues to elevate the movable platform 605 of the exchangeable printing frame 606 thereby causing all the powder in the exchangeable printing frame 606, as well as the printed objects encased in the powder, to be pushed into the transfer chamber 618 through the opening in the bottom wall thereof. The transfer chamber 618 and the receiving area 604 are connected with an airtight seal to prevent or minimize the escape of powder when the lift mechanism 624 pushes the powder and objects from the exchangeable printing frame 606 into the transfer chamber 618.

In the transfer chamber 618 is a movable decoating wall panel 632. Before the lift mechanism 624 pushes the powder and objects into the transfer chamber 618, the movable decoating wall panel 632 is located in the transfer chamber 618 at an end opposite the processing chamber 620. The movable decoating wall panel 632 is operable to translate horizontally across the transfer chamber 618 to push the powder and objects encased therein received from the receiving area 604 horizontally through the transfer chamber 618 toward the opening in the bottom wall of the transfer chamber 618 into the processing chamber 620 so that the powder and objects encased therein drop into the processing chamber 620. In one embodiment, a sealing member (not shown) engages the decoating wall panel 632 to provide an airtight seal around it.

An upper bellows 634 connects the transfer chamber 618 to the processing chamber 620. The upper bellows 634 forms an airtight seal between the transfer chamber 618 and the processing chamber 620 yet allows for relative movement between the transfer chamber 618 and the processing chamber 620.

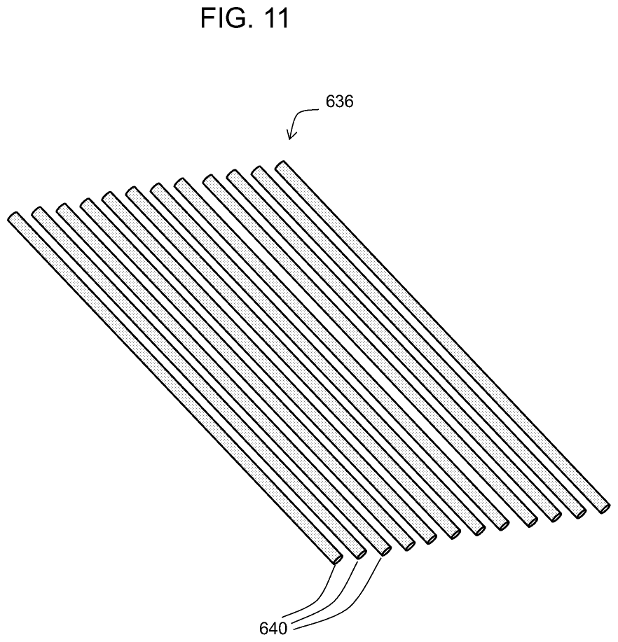

The processing chamber 620 includes a processing platform 636. The processing platform 636 is located approximately midway between a top and a bottom of the processing chamber 636. The processing platform 636 has a structure that allows powder to pass through it but prevent objects from passing through it. Referring to FIG. 11, in this embodiment, the processing platform 636 is formed of a plurality of rods 640 that extend across the processing chamber 620. Each of the rods 640 has a diameter of approximately 6.35 mm (¼ inch). The rods 640 are spaced from each other leaving a gap of approximately 3.17 mm (⅛ inch) between adjacent rods. The rods 640 are composed of a durable material, such as stainless steel. The rods 640 are affixed to the sides of the processing chamber 620. When the movable wall panel 632 pushes the powder and objects encased therein into the processing chamber 620, the powder and objects encased therein fall onto the processing platform 636.

Referring again to FIG. 9, located in a bottom floor 648 of the processing chamber 620 is an exit chute 652. The bottom floor 648 of the processing chamber 620 is slanted downward towards the exit chute 652.

Located below the exit chute 652 is a powder collection bin 656. A lower bellows 660 connects the exit chute 652 to the powder collection bin 656. The lower bellows 660 forms an airtight seal between the processing chamber 620 and the powder collection bin 656 yet allows for relative movement between the powder collection bin 656 and the processing chamber 620.

The processing chamber 620 is supported from its bottom on a plurality of springs 664 (only one of which is shown). The springs 664 allow the processing chamber 620 to move or vibrate. In one embodiment the springs 664 allow the processing chamber 620 to move vertically up and down.

Connected to the bottom of the processing chamber 620 is a driver (or shaker) 670. The driver 670 is a device that has an output shaft that oscillates up-and-down at selectable speeds, frequencies, and amplitudes. The connection of the driver 670 to the processing chamber 620 is fixed so that the driver 670 can cause the processing chamber 620 to move up and down at selectable speeds, frequencies, and amplitudes. A cooling device, such as a fan, (not shown) is associated with the driver 670 to reduce or prevent overheating.

The system 600 can be operated to receive an entire exchangeable printer frame containing 3D printed objects still encased in powder, automatically dispense the powder and objects encased from the exchangeable printer frame into the processing chamber whereupon the powder can be removed from the objects. The embodiment of the system 600 provides for recovery of much or all the unfused powder with minimal or no handling on the part of an operator.

Once the powder and objects encased in the powder (and optionally abrasive material) are located on the processing platform 636 in the processing chamber 620, the driver 670 is operated to cause the entire processing chamber 620 to move (or oscillate or vibrate). As described in connection with other embodiments, the operating parameters, i.e., including frequency, amplitude, and duration of vibration, are selectable. Selection of appropriate operating parameters, including frequency, amplitude, and duration of vibration, is based on factors including efficient removal of powder, reducing damage to the objects, and amount of powder to be removed. Selection of an appropriate frequency, amplitude, and duration of vibration takes into account information and parameters about the powder and the objects encased in the powder, including the sizes of the objects, wall thicknesses of the objects, material composition of the objects, internal and external surfaces, and internal passages, as well as other factors. In one embodiment, information and parameters about the objects are obtained from the design file used by the 3D printer to produce the objects. In this embodiment, information and parameters about the objects in the design file are used to select appropriate operating parameters, including frequency, amplitude, and duration of vibration, to depowder the objects in the processing chamber 620. One or more cycles, each with a different set of operating parameters, may be determined. Use of the design file information to select appropriate operating parameters for frequency, amplitude, and duration of vibration in the processing chamber 620 can be done automatically by software programming in the system 600, or alternatively the use of the design file information to select appropriate operating parameters for frequency, amplitude, and duration of vibration in the processing chamber 620 can be done manually or by an operator or by reference to previously stored recipes or profiles.

In one embodiment, the processing chamber 620 is vibrated at a subsonic frequency. Other higher or lower frequencies may be used including sonic or ultrasonic. For example, the processing chamber 620 is vibrated at a frequency between 1-500 hertz. The amplitude of displacement of the processing chamber 620 when it is vibrated is related to the frequency and acceleration. In exemplary embodiments, the displacement can be approximately from 0.0004 inches (0.01 mm) to 0.75 inches (2 cm).

In one embodiment, operating parameters, including frequency, amplitude, and duration, are selected to impart more than 1 g acceleration to the processing chamber 620. For example, operating parameters are selected to impart 2 g or more acceleration with a sinusoidal wave motion to the processing chamber 620. In other embodiments, a g force in the range 0.01 g to 8 g can be selected. When the processing chamber 620 is vibrated at greater than 1 g acceleration, objects and powder (which fall at 1g) in the processing chamber 620 become suspended above the processing platform 636 when the processing chamber 620 is accelerating downward. When the processing chamber 620 reverses direction and begins to accelerate upward, impacts occur between the upward moving processing platform 636 and the powder or objects which are falling downward toward the processing platform 636. These impacts can serve to shake the powder off of the objects. Likewise, if there are depowdered objects on the upward moving processing platform 636, there are impacts between these depowdered objects and falling powder or objects above the depowdered objects on the processing platform 636. These impacts can also serve to shake powder off of objects.

In one embodiment, the operating parameters (i.e., frequency, amplitude and duration of vibration) selected and applied to the processing chamber 620 are chosen to cause the objects encased in powder to vibrate in resonance. The objects encased in powder may have a resonant frequency that is different from the powder in which the objects are encased. When the processing chamber 620 is vibrated at a frequency that induces the objects to vibrate in resonance, the objects will vibrate (i.e., move) relative to the powder encasing them. This process can facilitate powder removal from the objects. This process can also facilitate powder removal from internal passages located inside the objects.

The amount of time required to depowder the objects in the printing frame can vary depending on the size of the objects, the geometries of the objects, temperature, and various other factors. For example, the duration of operation may range from approximately a minute to approximately an hour.

As the processing chamber 620 is vibrated, powder removed from the objects passes through the gaps between the rods 640 of the processing platform 636, falls to the bottom of the processing chamber 620, down the exit chute 652, and collects in the powder collection bin 656. The powder collection bin 656 is removable so that when the depowdering operation is finished, the entire powder collection bin 656, filled with powder, can be removed. A fork lift or other appropriate lift mechanism may be used, if appropriate. The powder collected in the powder collection bin 656 can be recycled or otherwise appropriately disposed of.

The system 600 includes a ventilation system (e.g., air circulation). The ventilation system is designed to reduce or eliminate air or powder from escaping from inside the housing 602. The ventilation system maintains a pressure inside the housing lower than the air pressure outside the housing 602. Located in the housing 602 directly adjacent the location of the cooling device 610 is an air inlet 680, shown in FIG. 10. An air filter (not shown) is located directly behind the air inlet 680. The system 600 includes first and second exhaust stacks 684 and 688 connected to and extending from the top of the housing 602. One or more air filters (not shown) are located in line with each of the exhaust stacks 684 and 688. The ventilation system includes one or more fans 682 (shown in FIG. 9) associated with the exhaust stacks 684 and 688. The fans 682 draw air into the housing 602 through the air inlet 680 and expel air from the housing 602 through the first and second exhaust stacks 684 and 688. The doors and panels on the housing 602 are airtight and include airtight seals to reduce or prevent passage of air into or out of the housing except through the air inlet 680 and exhaust stacks 684 and 688.

As shown in FIG. 10, the housing 602 includes a viewing window 690. The viewing window 690 on transfer chamber is located adjacent to the transfer chamber 618. The viewing window 690 enables an operator to view the contents of the transfer chamber 618 as well as into the processing chamber 620. A light fixture 692 (shown in FIG. 9) is located in the transfer chamber 618 to help viewing the interior of the transfer chamber 618 and the processing chamber 620 through the viewing window 690.

The system 600 includes one or more cameras 700 and 702 located inside the housing 602. More specifically, the cameras 700 and 702 are located in the transfer chamber 618. One of the cameras 700 is aimed toward the receiving area end of the transfer chamber 618. The other camera 702 is aimed downward toward the processing chamber 620. The outputs of the cameras 700 and 702 are provided to the control panel 601 where the video from the cameras can be viewed. The outputs of the cameras 700 and 702 are also stored as data files for later viewing and analysis.

The embodiment of the system 600 includes sound insulation material. The processing chamber 620 can be operated at audible frequencies. Sound insulation can be installed lining interior sides of the panels from which the housing 602 is formed to reduce noise levels outside the system 600 during operation.

The housing 602 and internal compartments and chambers, including the receiving area 604, transfer chamber 618, processing chamber 620, and powder collection bin 656 are composed of durable, rigid, non-reactive materials such as steel, powder-coated steel, stainless steel, aluminum, or high-strength plastics.

The system 600 includes various sensors used to monitor operation of the system and to provide that the system and its components are operating properly. An accelerometer is associated with the driver 670 and another accelerometer is associated with the processing chamber 620 to measure and detect movement of these components. One or more temperature sensors position acceleration (e.g., thermocouples, infrared sensors, etc.) are associated with the transfer chamber 618, the cooling device 610, the driver 670, and the powder collection bin 656. Sound sensors are located inside and/or outside the housing 602 to detect noise levels. Pressure differential sensors are located on upstream and downstream sides of the filters, for example to detect clogging. Motion or displacement sensors are associated with the door panels to detect closure status. One or more particle sensors may be located inside the housing 602 to detect for possible leakage of powder from the processing chamber 620. The system 600 may include other sensors in addition to those mentioned above. The sensors provide their outputs to the controller of the system 600.

The system 600 includes several advantages.

One advantage of the system 600 is provided by the processing platform 636. As described above and shown in FIG. 11, the processing platform 636 is formed of a plurality of rods 640 that extend across the processing chamber 620. The processing platform 636 allows powder shaken off the objects to pass through gaps between the rods 640 and fall to the bottom of the processing chamber 620 while preventing the objects being depowdered from passing through. The rods 640 present relatively low friction horizontally thereby allowing objects to move horizontally along the rods 640 across the processing platform 636. Providing gaps that allow objects to move horizontally along the processing platform 636 may be preferable to providing a grid of small openings because an object may become stuck in a small opening thereby clogging the opening and possibly damaging the object. However, by using rods with gaps between them, objects are able to slide horizontally thereby not clogging the gaps and reducing the possibility of damage to the objects.

Another advantage of the embodiment of the system 600 in FIGS. 9 and 10 is that it can handle large outputs from a powder bed 3D printer. The system 600 is capable of removing the powder from all the objects in an entire exchangeable printing frame at one time in a single operation. Such a frame can weigh up to approximately 90 kg (200 pounds).

Another advantage of the system 600 in FIGS. 9 and 10 is that it reduces handling of the objects from the 3D printer. With the system 600, the entire printing frame containing the objects and the unfused powder is installed in the receiving area without the need for an operator to remove the powder and objects from the printing frame. Removal of the powder and objects takes place internally in the housing of the system 600 thereby reducing the amount of powder escaping and increasing the amount of powder that can be recovered or recycled.

### Fourth Alternative Embodiment

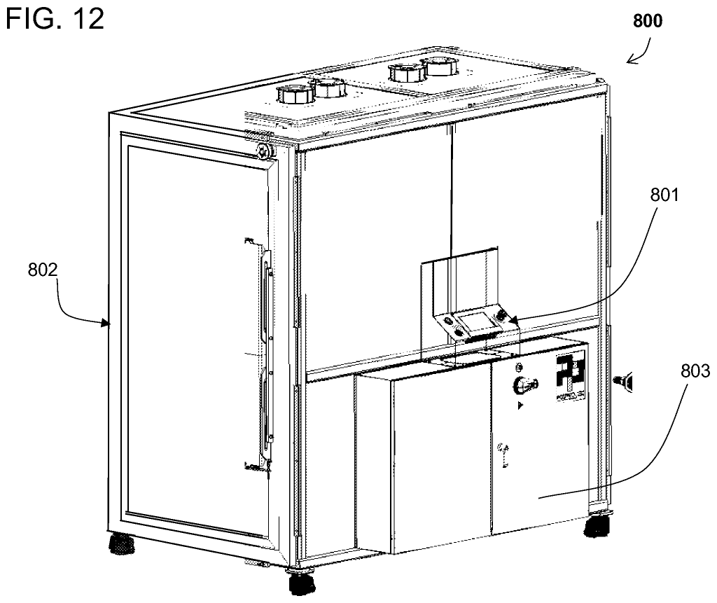

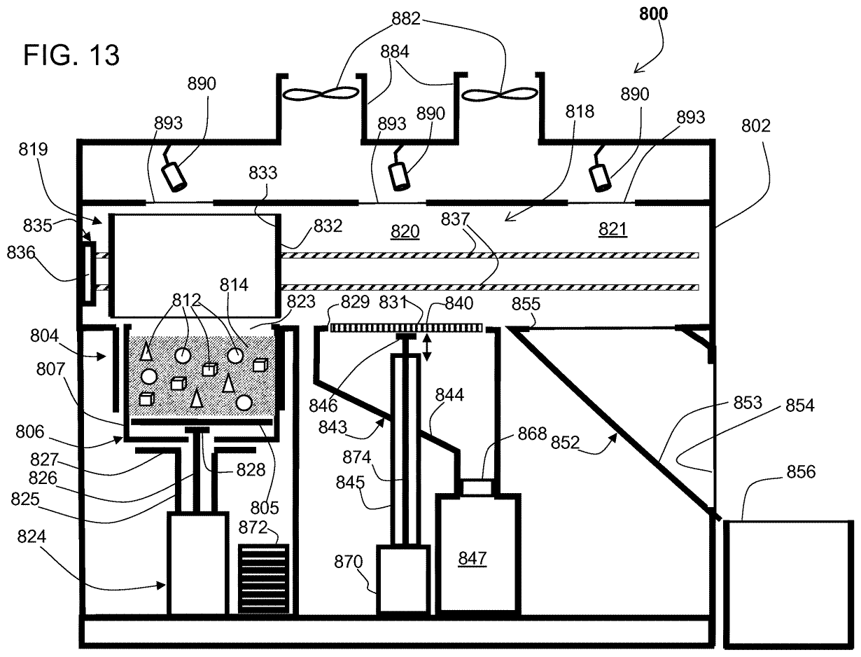

FIGS. 12 and 13 show another alternative embodiment. FIGS. 12 and 13 show a system 800 for removing powder from additively manufactured objects. The system 800 uses processes similar to the other embodiments disclosed herein to remove powder from 3D printed objects. The system 800 includes additional components and features including features that facilitate handling and transfer of objects encased in powder from a 3D printer that produced the objects.

The system 800 includes a housing 802. On the housing 802 is a control panel 801, shown in FIG. 12. The control panel 801 is located at a front side of the housing 802 on an enclosure 803 located on the front side of the housing 802. The control panel 801 includes a user interface that enables an operator to input instructions, commands, parameters, and other information into the system 800 as well as receive information and other output from the system 800. The control panel 801 is connected to a controller (not shown) of the system 800, which is located inside the enclosure 802.

FIG. 13 shows a vertical cutaway diagram view of the system 800. Inside the housing 802 is a loading area 804. The loading area 804 has a size and dimensions to receive therein an exchangeable printing frame 806 from a 3D powder bed printer. The exchangeable printing frame 806 may be the same or similar to the exchangeable printing frame 606 described in connection with the embodiment of the system 600 shown in FIG. 9. The exchangeable printing frame 806 is a box-like structure comprised of outer side walls 807 with an open upper side and a bottom floor comprised of a movable platform 805 that can translate vertically up and down within the outer side walls 807.

In the system 800 in FIGS. 12 and 13, the exchangeable printing frame 806 is fitted into the loading area 804. In this embodiment, the loading area 804 includes a tray (not shown) that slides outward automatically to receive therein the exchangeable printing frame 806. After the exchangeable printing frame 806 is installed in the tray, the tray slides back into the loading area 804. The exchangeable printing frame 806 contains printed parts 812 that were printed by the 3D printer as well as unfused powder 814 surrounding and encasing the printed parts 812. In this embodiment, the loading area 804 has specific dimensions to accommodate an exchangeable printing frame from a specific 3D printer. In alternative embodiments, the loading area 804 may have different dimensions to accommodate sizes of frames from different printers. Alternatively, the loading area 804 may have adjustable dimensions that can be adjusted to accommodate different sizes of frames from different 3D printers.

Above the receiving area 804 is a transfer channel 818. The transfer channel 818 extends horizontally across the upper interior of the housing 802. The transfer channel 818 includes three sections or zones: a receiving zone 819, a processing zone 820, and a parts recovery zone 821. The receiving zone 819 is directly above the loading area 804. A bottom wall of the transfer channel 818 in the receiving zone 819 includes a first opening 823 so that a bottom of the receiving zone 819 is open to the loading area 804.

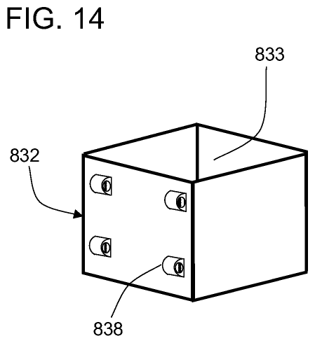

Located in the transfer channel 818 is a movable container 832. FIG. 14 shows the movable container 832 removed from the transfer channel 818. The movable container 832 is a box-like structure with four vertical sides walls 833. The movable container 832 is open at the top and bottom. In one embodiment, the movable container 832 has dimensions of 51 cm (20 inches) by 56 cm (22 inches) by 46 cm (18 inches). In one embodiment, the movable container 832 is composed of stainless steel although other materials may be suitable.

Referring again to FIG. 13, the movable container 832 is movable in the transfer channel 818 from a position in the receiving zone 819, to a position in the processing zone 820, to a position in the parts recovery zone 821. In FIG. 13, the movable container 832 is shown in the receiving zone 819.

A lift mechanism 824 is located in the loading area 804. The lift mechanism 824 is located below that portion of the loading area 804 that receives the exchangeable printing frame 806. The lift mechanism 824 includes two components: an outer portion component 825 and an inner portion component 826. An upper end 827 of the outer portion component 825 is adapted to engage the outer walls 807 of the exchangeable printing frame 806 when the exchangeable printing frame 806 is in the loading area 804. An upper end 828 of the inner portion component 826 is adapted to engage the movable platform 805 of the exchangeable printing frame 806 when the exchangeable printing frame 806 is in the loading area 804. The lift mechanism 824 is operable to elevate the exchangeable printing frame 806 upward toward the opening 823 into the transfer channel 818.

Located in the transfer channel 818 is an actuator 835. The actuator 835 is connected to the movable container 832. The actuator 835 is operable to move the movable container 832 in the transfer channel 818 between the positions in the receiving zone 819, the processing zone 820 and the parts recovery zone 821. In this embodiment, the actuator 835 comprises a motor 836 operable to rotate threaded guide rods 837 that engage corresponding threaded openings located in brackets 838 (shown in FIG. 14) attached to sides of the movable container 832. Rotation of the threaded rods 837 causes the movable container 832 to move between positions in the receiving zone 819, the processing zone 820, and the parts recovery zone 821 in the transfer channel 818.

In the processing zone 820, the bottom wall of the transfer channel 818 includes a second opening 829. Located in the second opening 829 is a processing platform 840. The processing platform 840 has a structure that allows the powder 814 to pass through it but prevents the printed parts 812 from passing through it. In this embodiment, the processing platform 840 has a grid pattern of openings 831, each opening having dimensions of approximately 0.200 inches (0.5 cm) in diameter.

Located below the processing platform 840 is a powder collection chute 843. The powder collection chute 843 is a duct with a slanted bottom wall 844. A bottom of the slanted bottom wall 844 of the powder collection chute 843 opens into a powder collection cannister 847. A sieve 868 is located inline above the powder canister 847. In one embodiment, the powder collection cannister 847 has a capacity of approximately 40 liters.

Also located below the processing platform 840 is a driver (or shaker) 870. The driver 870 has an output shaft 874 that oscillates up-and-down at selectable speeds, frequencies, and amplitudes. The output shaft 874 is located in and extends through a hollow tubular shaft 845 that extends through an opening in the slanted bottom wall 844 of the powder collection chute 843. An upper end 846 of the output shaft 874 is connected to the bottom side of the processing platform 840. The connection of the driver 870 to the processing platform 840 is fixed so that the driver 870 can cause the processing platform 840 to move up and down at selectable speeds, frequencies, and amplitudes. In one embodiment, the driver 870 is a voice coil motor.

In the parts recovery zone 821, the bottom wall of the transfer channel 818 includes a third opening 855. Located below the third opening 855 is a parts collection chute 852. The parts collection chute 852 is a duct with a slanted bottom wall 853. The slanted bottom wall 83 of the parts collection chute 852 leads to an opening 854 at the side of the housing 802. A parts recovery bin 856 is located below the opening 854 of the parts collection chute 852.

The system 800 may include one or more cooling devices 872. The one or more cooling devices 872 may be located in the loading area 804 or elsewhere inside the housing 802. In one embodiment, the cooling devices 872 include a radiator that receives a circulating fluid, such as chilled water or water from a facility water supply. The cooling devices 872 serve to reduce the temperature of the powder and objects in the exchangeable printing frame 806, if necessary. In one embodiment, it is preferable that the powder 814 and printed parts 812 in the exchangeable printing frame 806 be below approximately 100° C.

The system 800 includes a ventilation system (e.g., air circulation). The ventilation system is designed to reduce or eliminate air or powder from escaping from inside the housing 802. The ventilation system maintains a pressure inside the housing lower than the air pressure outside the housing 802. The system 800 includes exhaust stacks 884 connected to and extending from the top of the housing 802. One or more air filters (not shown) may be located in line with each of the exhaust stacks 884. The ventilation system includes one or more fans 882 associated with the exhaust stacks 884. The fans 882 are operable to expel air from the housing 802 through the exhaust stacks 884.

The system 800 includes cameras 890 located inside the housing 802. More specifically, the cameras 890 are located above the transfer channel 818 above openings 893 located in a top side of the transfer channel 818. The openings 893 may be covered by transparent panes. The cameras 890 are oriented to obtain imagery of the receiving zone 819, the processing zone 820, and the parts recovery zone 821. The outputs of the cameras 890 are provided to the control panel 801 where the video from the cameras 890 can be viewed. The outputs of the cameras 890 are also stored as data files for later viewing and analysis.

The embodiment of the system 800 may include sound insulation material. The system 800 can be operated at audible frequencies. Sound insulation can be installed lining interior sides of the panels from which the housing 802 is formed to reduce noise levels outside the system 800 during operation.

The system 800 may include various sensors used to monitor operation of the system and to provide that the system and its components are operating properly. Accelerometers may be associated with the driver 870 and the processing platform 840 to measure and detect movement of these components. One or more temperature sensors (e.g., thermocouples, infrared sensors, etc.) may be associated with the transfer channel 818, the cooling devices 872, the driver 870, and the powder collection cannister 847. Sound sensors may be located inside and/or outside the housing 802 to detect noise levels. Pressure differential sensors may be located to detect clogging. Motion or displacement sensors may be associated with the door panels. One or more particle sensors may be located inside the housing 802 to detect for possible leakage of powder. The system 800 may include other sensors in addition to those mentioned above. The sensors provide their outputs to the controller of the system 800.

### Operation

To operate the system 800 to depowder parts, the front panels of the housing 802 are opened, and the exchangeable printer frame 806 containing the printed parts 812 and powder 814 is installed into the loading area 804 by placing the exchangeable printer frame 806 on the retractable tray (not shown) which is slid back into the lift mechanism 824. At this stage, the movable container 832 is empty and located in the receiving zone 819. Then, the front panels of the housing 802 are closed. The system 800 is operated to cause the lift mechanism 824 to push the printed parts 812 and powder 814 contained in the exchangeable printer frame 806 from the loading area 804 into the receiving zone 819. The lift mechanism 824 pushes an upper side of the exchangeable printing frame 806 upward so that it is aligned with a bottom of the transfer channel 818. Then, the outer portion component 825 of the lift mechanism 824 ceases to elevate the outer walls 807 of the exchangeable printing frame 806 while the inner portion component 826 continues to elevate the movable platform 805 of the exchangeable printing frame 806 thereby causing all the powder 814 and printed parts 812 in the exchangeable printing frame 806 to be pushed through the opening 823 in the bottom wall of the transfer channel 818 into the movable container 832.

Once the powder 814 and printed parts 812 are located on the movable container 832 in the receiving zone 819, the actuator 835 is operated to slide the movable container 832 from the receiving zone 819 to the processing zone 820. When the movable container 832 is in the processing zone 820, the driver 870 is operated to cause the processing platform 840 to move (or oscillate or vibrate). As described in connection with other embodiments, the operating parameters, i.e., including frequency, amplitude, and duration of vibration, are selectable. Selection of appropriate operating parameters, including frequency, amplitude, and duration of vibration, is based on factors including efficient removal of powder, reducing damage to the objects, and amount of powder to be removed. Selection of an appropriate frequency, amplitude, and duration of vibration takes into account information and parameters about the powder and the printed parts encased in the powder, including the sizes of the printed parts, wall thicknesses of the objects, material composition of the printed parts, internal and external surfaces, and internal passages, as well as other factors. In one embodiment, information and parameters about the printed parts are obtained from the design file used by the 3D printer to produce the objects. In this embodiment, information and parameters about the printed parts in the design file are used to select appropriate operating parameters, including frequency, amplitude, and duration of vibration, to depowder the objects on the processing platform 840. One or more cycles, each with a different set of operating parameters, may be determined. Use of the design file information to select appropriate operating parameters for frequency, amplitude, and duration of vibration in the processing zone 820 can be done automatically by software programming in the system 800, or alternatively the use of the design file information to select appropriate operating parameters for frequency, amplitude, and duration of vibration in the processing zone 820 can be done manually or by an operator or by reference to previously stored recipes or profiles.

In one embodiment, the processing platform 840 is vibrated at a subsonic frequency of 38 hertz. Other higher or lower frequencies may be used including sonic or ultrasonic. For example, the processing platform 840 can be vibrated at frequencies between 1-100 hertz, although frequencies as high as 500 hertz may also be suitable. The amplitude of displacement of the processing platform 840 when it is vibrated is related to the frequency and acceleration. In exemplary embodiments, the displacement can be approximately 0.75 inches (2 cm).

In one embodiment, operating parameters, including frequency, amplitude, and duration, are selected to impart more than 1 g acceleration to the processing chamber 620. For example, operating parameters are selected to impart 2 g or more acceleration with a sinusoidal wave motion to the processing platform 840. When the processing platform 840 is vibrated at greater than 1 g acceleration, objects and powder (which fall at 1 g) in the processing zone 820 become suspended above the processing platform 840 when the processing platform 840 is accelerating downward. When the processing platform 840 reverses direction and begins to accelerate upward, impacts occur between the upward moving processing platform 840 and the powder or printed parts which are falling downward toward the processing platform 840. These impacts can serve to shake the powder off of the printed parts. Likewise, if there are depowdered printed parts on the upward moving processing platform 840, there are impacts between these depowdered printed parts and falling powder or printed parts above the depowdered printed parts on the processing platform 840. These impacts can also serve to shake powder off of printed parts.

In one embodiment, the operating parameters (i.e., frequency, amplitude and duration of vibration) selected and applied to the processing platform 840 are chosen to cause the printed parts encased in powder to vibrate in resonance. The printed parts encased in powder may have a resonant frequency that is different from the powder in which the printed parts are encased. When the processing platform 840 is vibrated at a frequency that induces the objects to vibrate in resonance, the printed parts will vibrate (i.e., move) relative to the powder encasing them. This process can facilitate powder removal from the printed parts. This process can also facilitate powder removal from internal passages located inside the printed parts.

The amount of time required to depowder the printed parts in the printing frame can vary depending on the size of the printed parts, the geometries of the printed parts, temperature, and various other factors. For example, the duration of operation may range from approximately less than 10 minutes to approximately more than an hour.

As the processing platform 840 is vibrated, powder 814 removed from the printed parts 812 passes through the openings 831 in the processing platform 840, falls into the powder collection chute 843, and falls to the powder collection cannister 847. The sieve 868 may be used to separate reusable powder from powder to be discarded. After the powder 814 passes through the sieve 868 into the powder collection cannister 847, the powder 814 may be removed via a powder collection pump (not shown) and recycled or disposed of.

After the powder 814 is removed from the printed parts 812, vibration of the processing platform 840 is stopped. At this stage, the printed parts 812, with all or most of the powder removed, are located on the processing platform 840 inside the movable container 832. The actuator 835 is operated to slide the movable container 832 from the processing zone 820 to the parts recovery zone 821. When the movable container 832 is in the parts recovery zone 821, the parts 812 fall through the third opening 855 in the bottom wall of the transfer channel 818 into the parts collection chute 852, through the opening 854 and into the parts recovery bin 856.

The powder collection cannister 847 is removable so that when the depowdering operation is finished, the entire powder collection cannister 847 and any powder collected therein can be removed. The powder collected in the powder collection cannister 847 can be recycled or otherwise appropriately disposed of.

The housing 802 and internal compartments and chambers are composed of durable, rigid, non-reactive materials such as steel, powder-coated steel, stainless steel, aluminum, or high-strength plastics.

### Fifth Alternative Embodiment

FIG. 15 shows another alternative embodiment. FIG. 15 shows a system 900 for removing powder from additively manufactured objects. The system 900 uses processes similar to the other embodiments disclosed herein to remove powder from 3D printed objects. The system 900 includes additional components and features that facilitate removal of powder from objects made by a 3D printer.

The system 900 includes a housing 902. On the housing 902 is a control panel (not shown) with a user interface that enables an operator to input instructions, commands, parameters, and other information into the system 900 as well as receive information and other output from the system 900. The control panel is connected to a controller (not shown) located inside the housing 902.

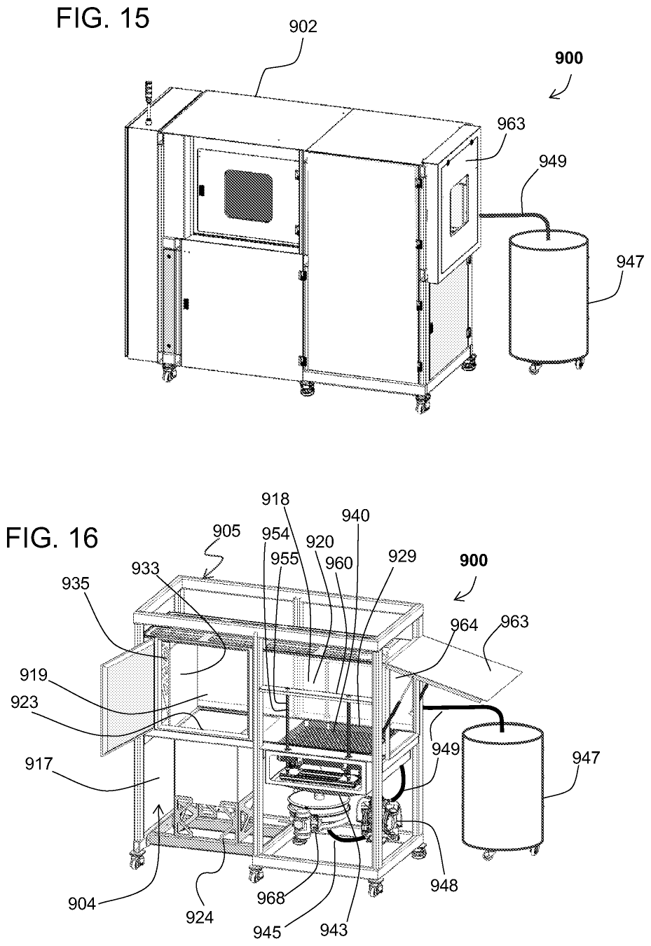

FIG. 16 shows a perspective view of the system 900 with panels of the housing 902 removed. The system 900 includes a frame 905. Located in the frame 905 is a loading area 904. The loading area 904 includes a lift section 917 and a transfer section 919. The transfer section 919 is located above the lift section 917. Located in the lift section 917 is a lift mechanism 924. The loading area 904 has a size and dimensions to receive therein an exchangeable printing frame from a 3D powder bed printer. As explained in more detail below, the loading area 904 may have different designs to accommodate different types and sizes of exchangeable printing frames used in different models and types of powder bed 3D printers. Alternatively, the loading area 904 may be adjustable or utilize exchangeable fixtures that can be adjusted to accommodate different types and sizes of exchangeable printing frames from different 3D printers.

The exchangeable printing frame in this embodiment may be the same or similar to the exchangeable printing frame 606 described in connection with the embodiment of the system 600 shown in FIG. 9 or the exchangeable printing frame 806 described in connection with the embodiment of the system 800 shown in FIG. 13. The exchangeable printing frame is a box-like structure comprised of outer side walls with an open upper side and a bottom floor comprised of a movable platform that can translate vertically up and down within the outer side walls.

A transfer channel 918 extends horizontally across an upper interior of the housing 902 inside the frame 905. The transfer channel 918 includes two sections. The transfer channel 918 includes the transfer section 919, which is part of the loading area 904. Thus, the transfer section 919 forms part of the loading area 904 as well as part of the transfer channel 918. A bottom wall of the transfer channel 918 in the transfer section 919 includes a first opening 923 so that a bottom of the transfer section 919 is open to the lift section 917. The transfer channel 918 also includes a processing section 920. The processing section 920 is located adjacent to the transfer section 919.

Located in the transfer channel 918 is a movable wall 933. The movable wall 933 has a flat vertical rectangular shape with dimensions that conform to an interior cross section of the transfer channel 918. An actuator 935 is located in the transfer channel 918 in the loading area 904. The actuator 935 is connected to the movable wall 933 and is operable to move the movable wall 933 along the transfer channel 918 from a position in the transfer section 919 to a position in the processing section 920 and back.

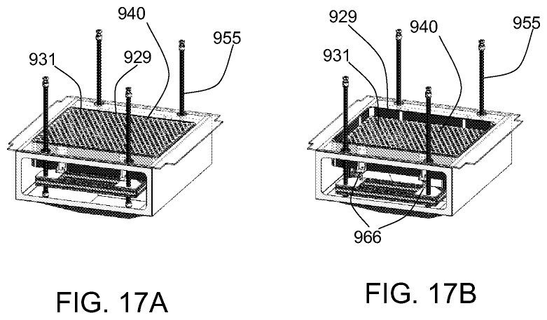

In the processing section 920, a bottom wall of the transfer channel 918 includes a second opening 929. Located in the second opening 929 is a platform grate 940. The platform grate 940 has a structure that allows powder to pass through it but prevents printed objects from passing through it. In this embodiment, the platform grate 940 has a grid pattern of openings 931, as shown in FIGS. 17A and 17B. In this embodiment, each of the openings 931 has dimensions of approximately ⅛ inch (0.32 cm) in diameter. In alternative embodiments, the platform grate 940 can have openings of different sizes. The platform grate 940 can be shifted vertically between an upper position shown in FIG. 17A and a lower position shown in FIG. 17B.

Referring again to FIG. 16, located below the platform grate 940 is a powder collection chute 943. An inlet side of a sieve 968 connects to an opening at a bottom of the powder collection chute 943. A first hose 945 connects a bottom of the sieve 968 to an inlet of a powder pump 948. In one embodiment, the powder pump 948 is a model PP10A-AAS-AAA-A manufactured by ARO, although other models by other manufacturers may be used. A second hose 949 connects an outlet of the powder pump 948 to a powder collection vessel 947. The powder pump 948 is adapted to cause a suction that draws unwanted powder from the powder collection chute 943 and expel the unwanted powder via the second hose 949 to the powder collection vessel 947. In one embodiment, the powder collection vessel 947 has a filtered port that allows air to escape, but not powder.

The platform grate 940 is attached to a mechanism 954 that is configured to impart vibration to the platform grate 940. In this embodiment, the mechanism 954 is located above the platform grate 940 and attached to the platform grate 940. In this embodiment, the mechanism 954 is at least one fluidic muscle 955. In one embodiment, the platform grate 940 is attached to four fluidic muscles 955, as shown in FIGS. 17A and 17B. In other embodiments, more or fewer fluidic muscles 955 may be used. In one embodiment, each fluidic muscle 955 is a model DMSO-20-625-AM-RM manufactured by Festo, although other models by other manufacturers may be used.

Bottom ends of each of the four fluidic muscles 955 are attached to an upper side of the platform grate 940 at the corners thereof, as shown in FIGS. 17A and 17B. Upper ends of the four fluidic muscles 955 are attached to brackets that are adjustable for alignment. These brackets are attached to a horizontal frame member 960, which in turn is attached to the rest of the frame 905, as shown in FIG. 16. Upper ends of the other two of the four fluidic muscles 955 are attached to a corresponding horizontal frame member (not shown), which is similarly connected to the frame 905.

The fluidic muscles 955 are connected to solenoid valves that cause them to contract. The solenoid valves are in turn connected to a power source of the system 900. Springs 966 (shown in FIG. 17B) are connected between the platform grate 940 and the frame 905. The springs 966 are oriented to push the platform grate 940 in a direction opposite the direction of contraction by the fluidic muscles 955. In this embodiment, four springs 966 are positioned around the platform grate 940 at the corners thereof. The fluidic muscles 955 are configured to be operated to retract in pulses at selectable speeds, frequencies, and amplitudes. The fluidic muscles 955 in combination with the springs 966 cause the platform grate 940 to vibrate vertically at selectable speeds, frequencies, and amplitudes. In this embodiment, the operation of the fluidic muscles 955 is synchronized so that the four fluidic muscles 955 move or pulse simultaneously at the same time, with the same frequency and amplitude. In other embodiments, the fluidic muscles 955 can be operated non-synchronously. In one embodiment, the fluidic muscles 955 operate synchronously at a frequency of 15-20 Hz, although other frequencies, higher or lower, can be used. In one embodiment, the fluidic muscles 955 are operated to cause the platform grate 940 to move with an amplitude of 7.5-10 cm (3-4 inches) although other amplitudes may be used. The amplitude or frequency may change as unwanted material is removed, or alternatively the amplitude and frequency may be kept the same. The fluidic muscles 955 may be operated to cause the unwanted material or the additively manufactured parts to vibrate at a resonant frequency or a non-resonant frequency.

### Operation

The operation of the system 900 to depowder parts is similar to operation of the system 800. The front panels of the loading area 904 of the housing 902 are opened and an exchangeable printer frame containing printed parts and powder is installed into the loading area 904. As stated above, the loading area 904 may have different designs to accommodate different types and sizes of exchangeable printing frames used in different models and types of powder bed 3D printers. In one type of design, an exchangeable printer frame is positioned in the transfer section 919 of the loading area 904. In this design, the lift mechanism 924 is initially extended in an upper position. The bottom floor of the exchangeable printer frame is removed. The system 900 is operated to cause the lift mechanism 924 to move into a lower position, causing the printed objects and powder to move into a chamber located in the lift section 917 of the loading area 904. The exchangeable printer frame is removed from the transfer section 919. The lift mechanism 924 is operated to move from the lower position back to the upper position causing the printed objects and powder to be lifted back into the transfer section 919. At this stage, the printed objects and powder are located in the transfer section 919 and are ready to be moved along the transfer channel 918 to the processing section 920.

In another type of design, the lift mechanism 924 is initially in a lower position in the loading area 904. In this design, an exchangeable printer frame is positioned in the lower portion of the loading area 904 in the lift section 917 with the lift mechanism 924 positioned against the bottom of the exchangeable printer frame located in the lift section 917. The system 900 is operated to cause the lift mechanism 924 to move from the lower position to an upper position, pushing the bottom of the exchangeable printer frame upward and causing the printed objects and powder to move upward out of the exchangeable printer frame. The lift mechanism 924 causes the printed objects and powder to be lifted into the transfer section 919. At this stage, the printed objects and powder are located in the transfer section 919 and are ready to be moved along the transfer channel 918 to the processing section 920.

After the printed objects and powder have been positioned in the transfer section 919, the actuator 935 is operated to move the movable wall 933 thereby pushing the printed objects and powder along the transfer channel 918 from the transfer section 919 to the processing section 920. The movable wall 933 is operated to move it to an edge of the platform grate 940 so that the printed objects and powder are positioned directly on the platform grate 940. When the movable wall 933 pushes the printed objects and powder into the processing section 920 onto the platform grate 940, the platform grate 940 may be in either an upper position, as shown in FIG. 17A or a lower position as shown in FIG. 17B. Before the fluidic muscles 955 are operated, the platform grate 940 may be lowered into the lower position, as shown in FIG. 17B.

The fluidic muscles 955 are operated to impart vibration to the platform grate 940. In one embodiment, the fluidic muscles 955 are operated at approximately 15-20 Hz, although frequencies outside that range can be used. The vibration is transferred to the powder and the printed objects causing the powder to fall off of the printed objects. The powder falls through the platform grate 940 into the powder collection chute 943 and through the sieve 968. The powder is drawn through the sieve 968 and through the first hose 945 by the powder pump 948. The powder pump 948 expels the powder via the second hose 949 into the powder collection vessel 947.

After the powder has been removed from the objects, the now depowdered objects are located on the platform grate 940. The system 900 is operated to cause the fluidic muscles 955 to stop vibrating. A panel 963 over an opening 964 on a side of the housing 902 is opened. The depowdered objects are removed from the platform grate 940. Removal of the depowdered objects from the platform grate 940 may be done manually or by automatic means, such as with a robotic mechanism. In one embodiment, the platform grate 940 is moved into the upper position shown in FIG. 17A and the movable wall 933 is operated to push the depowdered objects across the processing section 920 out the opening 964 into a container (not shown). The powder collected in the powder collection vessel 947 is recycled or otherwise disposed of.

### Other Alternatives

In one of the embodiments disclosed above, it was described that a solid abrasive media was placed with the parts to be cleaned or finished on the vibratory platform. In an alternative embodiment, the parts can be cleaned or finished without adding a solid abrasive media. In this alternative, the parts to be cleaned or finished are placed on the vibratory platform, which is vibrated for a period of time. This alternative may be suitable for some types of parts, such as particularly delicate parts.

In an embodiment described above, the system operates without application of other material removal technologies. In alternative embodiments, a system using a vibratory platform for removal of unwanted material may also use other technologies to supplement, augment or complement unwanted material removal. Such other technologies may include application of acoustic energy, pressurized sprays (liquid, solids, or gaseous) or application of chemicals, such as detergents. These other technologies may be incorporated into the same system or chamber that includes the vibratory platform or may be located in another chamber located adjacent to or in-line with the chamber that includes the vibratory platform.

In the embodiments in FIGS. 2, 5, 7A and 7B, the vibratory platform is solid. In an alternative embodiment, the vibratory platform includes openings so that any unwanted material detaching from the parts will fall through the openings to the bottom of the chamber. The openings may be of any suitable size or type, including without limitation a mesh construction. Instead of openings, the platform may be made of other constructions that allow material detaching from the parts to fall to the bottom of the chamber.

In embodiments disclosed above, the removal of unwanted material from an additively manufactured object can be conducted at room temperature. In alternative embodiments, heat may be applied in conjunction with a vibratory platform to facilitate removal of unwanted material from additively manufactured parts. To apply heat to facilitate removal of unwanted material from additively manufactured parts, a heating element may be included in the chamber of the system. The heater may be operated under control of the control unit. Alternatively, a heater may be operated based on input provided by a user through the user interface. In still further alternative embodiments, the system may include a cooling element to cool or refrigerate the air in the chamber during the material removal process. The cooling element may be operated under control of the control unit based on information contained in a profile or may be operated based on input provided by a user through the user interface. In further alternatives the system may include both a heating element and a cooling element.

In various different embodiments, different kinds of vibrations, different kinds of waveforms, different frequencies of waves, and different amplitudes of waves may be applied to the vibratory platform. Different kinds of waveforms include sine waves, square waves, sawtooth waves, as well as others. In some alternatives, multiple different vibrations, multiple different waveforms, multiple different amplitudes, multiple different frequencies of waves, or combinations thereof, may be applied at the same time to parts in the chamber. When applying different vibrations, waveforms, amplitudes or frequencies, the different vibrations, waveforms, amplitudes or frequencies may be applied from the same vibratory platform. The frequency being applied to the vibratory platform may be in the audible range, the ultrasonic range, or any other range.

In some of the embodiments described above, the interior of the chamber is maintained at atmospheric pressure. In other alternatives, the chamber may be maintained at a pressure that is higher or lower than atmospheric pressure, including near vacuum pressures. Alternatively, the pressure in the interior of the chamber may be changed during the material removal process. The pressure changes and the timing of the changes may be specified in the profile.

In the embodiments described above, an operating profile was selected by the user. In another alternative, the user may specify some or all the operating parameters manually. In another alternative, the operating parameters may be specified by the entity that performed the 3D printing portion of the additive manufacturing process.

In another alternative, the system automatically measures the progress of unwanted material removal while the material is being removed, and automatically auto-adjusts the operating parameters to improve or complete the removal process. This alternative may employ the AUTOMAT3D® technology developed by PostProcess Technologies, Inc. An embodiment of this technology is disclosed in copending patent application US20190315065, the entire disclosure of which is incorporated by reference herein. Sensors in the chamber measure the progress of the material removal process and feedback this information to a digital file that is used to modify or adjust the operating parameters.

In still another alternative, the unwanted material removal system is part of an overall additive manufacturing system that includes the object formation portion as well as the unwanted material removal portion. According to this alternative, the design file for object formation (e.g., a CAD file) and the operating profiles for material removal are part of an overall design file that both forms the object and removes unwanted material. In such an alternative, object formation and unwanted material removal are designed together for overall optimization and efficiency of object manufacturing. One alternative is the CONNECT3D® technology developed by PostProcess Technologies, Inc. An embodiment of this technology disclosed in copending patent application US20190275745, the entire disclosure of which is incorporated by reference herein. In some automated embodiments, the material removal process may be performed without user input or in a closed loop. Further, in some embodiments of an overall additive manufacturing system, the object may be moved on a conveyor, by robotic arm, or other means from the location where the object is formed to another location where vibratory energy is applied to remove unwanted material. In still other embodiments, vibratory energy is applied to remove unwanted material from an additively manufactured object in the same location (e.g., chamber) where the object is formed.

In some of the embodiments, the interior walls of the chamber are anechoic, or otherwise adapted so as to enhance or not detract from delivery of energy to the object(s) and material on the platform.

Different frequencies can be applied to the vibratory platform. In one embodiment, a frequency of between 75 and 135 Hertz is used. In another alternative, a frequency of between 35 -135 Hertz is used. In yet another alternative, a frequency of between 10-500 hertz is used. In still another alternative, a frequency of between 1-100 hertz is used. Other frequencies may be suitable. The platform may vibrate continuously or intermittently, for example to facilitate powder removal. Movement of the platform may be specified in the operating profile.

In embodiments described above, the medium inside the chamber is air. In alternative embodiments, other fluid media either gaseous or liquid may be used inside the chamber.

In another alternative embodiment, the platform rotates, i.e., a rotating turntable.

### Advantages

The disclosed embodiments have several advantages. One advantage is that the unwanted material can be readily recycled. Compared to material removal systems that use a liquid spray, the disclosed embodiments provide for relatively easier recovery of removed material for recycling. Compared to material removal systems that use a liquid spray, the disclosed embodiments do not require filtering of the liquid after spraying for reuse, recovery or recycling of the liquid and/or recycling of the removed material. Compared to material removal systems that use application of chemicals, the disclosed embodiments have the advantage that the unwanted material is removed from additively manufactured objects without having the objects come in contact with any chemicals. Furthermore, compared to material removal systems that use application of chemicals, the disclosed embodiments avoid the costs (including disposal costs) of such chemicals.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A system for removal of unwanted powder from additively manufactured objects manufactured by a powder bed 3D printer, said system comprising:
a housing;
a loading area located in the housing, said loading area sized and configured to receive an exchangeable printing frame used in the powder bed 3D printer and removed therefrom, wherein the exchangeable printing frame contains the additively manufactured objects and the unwanted powder;
a lift mechanism located in said loading area adapted to remove said additively manufactured objects and the unwanted powder from the exchangeable printing frame into a transfer section;
a platform grate located in said housing adjacent to said transfer section, said platform grate having openings therein;
an actuator in said housing adapted to move said additively manufactured objects and the unwanted powder from said transfer section onto said platform grate; and
a mechanism adapted to impart vibration to said platform grate, said mechanism located above and connected to said platform grate, wherein said mechanism adapted to impart vibration comprises at least one fluidic muscle,
wherein said unwanted powder is separated from said additively manufactured objects by operation of said mechanism imparting vibration to said platform grate and wherein said unwanted powder is removed by passing through the openings in said platform grate.

2. (canceled)

3. The system of claim 1 wherein said at least one fluidic muscle comprises four fluidic muscles.

4. The system of claim 1 wherein a lower end of said at least one fluidic muscle is connected to said platform grate and an upper side of said at least one fluidic muscle is connected to a frame member of said system.

5. The system of claim 1 further comprising at least one spring connected to said platform grate and oriented to push said platform grate in in a direction opposite from a direction said platform grate moves in response to retraction by said at least one fluidic muscle.

6. The system of claim 1 further comprising:
a powder pump located to draw the unwanted powder that had passed through said platform grate.

7. The system of claim 6 further comprising:
a powder collection vessel connected in-line with said powder pump and adapted to receive the unwanted powder drawn by said powder pump.

8. The system of claim 1 wherein the exchangeable printing frame is comprised of outer side walls with an open upper side and a bottom floor comprised of a movable platform that can translate vertically up and down within the outer side walls.

9. The system of claim 1 further comprising:
a movable wall located in the transfer section and movable by said actuator, said movable wall adapted to push said additively manufactured objects and said unwanted powder over said platform grate.

10. The system of claim 9 wherein said movable wall is adapted to push said additively manufactured objects across said platform grate and out of a door of said housing after said unwanted powder has been removed.

11. A method for removal of unwanted powder from additively manufactured objects manufactured by a powder bed 3D printer, the method comprising:
receiving the additively manufactured objects and the unwanted powder
onto a platform grate in a processing area of a housing; and
vibrating the platform grate with a fluidic muscle connected to said platform grate to separate the unwanted powder from the additively manufactured objects to cause the unwanted powder to fall through openings in the platform grate.

12. The method of claim 11 further comprising:
vibrating the platform grate at approximately 15-20 hertz for approximately between 10 minutes and 1 hour.

13. The method of claim 11 further comprising:
collecting the unwanted powder that fell through the openings in the platform grate in a powder collection vessel.

14. (canceled)

15. The method of claim 11 further comprising:
after vibrating the platform grate with the fluidic muscle connected to the platform grate to separate the unwanted powder from the additively manufactured objects, pushing the additively manufactured objects out of the processing area.

16.-33. (canceled)

34. The method of claim 11 further comprising:
recycling the unwanted powder.

35. The method of claim 11 wherein said platform grated is vibrated with an amplitude of between approximately 7.5 and 10 cm.

36. The method of claim 11 further comprising:
before receiving the additively manufactured objects and the unwanted powder onto the platform grate in the processing area, receiving an exchangeable printing frame containing the additively manufactured objects and the unwanted powder into a loading area of the housing, wherein the exchangeable printing frame was used in the powder bed 3D printer and removed therefrom;
removing the additively manufactured objects and the unwanted powder from the exchangeable printing frame into the loading area; and
conveying the additively manufactured objects and the unwanted powder from the loading area onto the platform grate in the processing area of the housing.

37. An apparatus for removal of unwanted powder from additively manufactured objects manufactured by a 3D printer, said apparatus comprising:
a housing;
a platform grate located in said housing, said platform grate having openings therein; and
one or more fluidic muscles connected to and located above said platform grate and adapted to impart vibration thereto,
wherein said unwanted powder is separated from said additively manufactured objects by operation of said one or more fluidic muscles imparting vibration to said platform grate and wherein said unwanted powder is removed by passing through the openings in said platform grate.

38. The apparatus of claim 37 further comprising:
a powder collection chute located below the platform grate; and
a powder collection cannister located below the powder collection chute and adapted to collect unwanted powder removed by vibration of the platform grate.

39. The apparatus of claim 37 wherein lower ends of said one or more fluidic muscles are connected to said platform grate and upper sides of said one or more fluidic muscles are connected to a frame member of said apparatus.

40. The apparatus of claim 37 further comprising at least one spring connected to said platform grate and oriented to move said platform grate in a direction opposite from a direction said platform grate moves in response to retraction by said one or more fluidic muscles.
